(19) United States
(12) Patent Application Publication
(10) Pub. No.: US 2006/0250213 A1
(43) Pub. Date: Nov. 9, 2006

(54) Biometric data controlled configuration

(76) Inventors: George R. Cain JR., Sunrise, FL (US); Joseph C. Namm, Plantation, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/482,992

(22) Filed: Jul. 7, 2006

Related U.S. Application Data
(62) Division of application No. 09/628,245, filed on Jul. 28, 2000.

(51) Int. Cl. G05B 19/00

(52) U.S. Cl. 340/5.52

(57) ABSTRACT

Biometric data can be read by a biometric sensor attached to a wireless communication device, remote control, or reconfigurable apparatus. The biometric data is run through a pattern recognition program to extract a set of essential biometric features that are used to identify a user. A set of configuration settings corresponding the user is retrieved and used to configure the wireless communication device or reconfigurable apparatus. The biometric data can be transmitted by the wireless communication device to a controller or by the remote control to the reconfigurable device in order to off load the pattern recognition function. Configuration settings can be transmitted from the remote control based on identification of the user by biometric data. Configuration settings can also be sent to the wireless communication device based on identification of the user.

### FIELD OF THE INVENTION

This invention pertains to the use of biometric identification, remote control, custom configuration, and wireless communication.

### BACKGROUND OF THE INVENTION

Reconfigurable apparatuses are frequently shared by multiple users. Each user may desire, or require that an apparatus be configured in accordance with a set of one or more configuration settings.

For example, it would be desirable to be able to easily share a limited number of portable radios among workers on different shifts at a facility. Some workers may require a different portable radio configuration than others. Configuration settings that need to be varied from one worker to another can include, for example, access frequencies, and talk group permissions. Such settings vary depending on the particular works position in a work group. Variable configurations settings could also include speaker volume, and display brightness.

Presently portable radio, reconfiguration is ordinarily accomplished by docking it to an interface device attached to a computer running a special reconfiguration application.

Currently there is also a system for changing configuration settings for a portable radio by replacing a smart card that includes various configuration settings in it's memory.

Other reconfigurable apparatus can also be shared by multiple users. As a further example, a car can be shared by multiple users in a family, or an outfit, such as a taxi company. Configuration settings for a car can include multiple degrees of freedom in seat position, steering wheel tilt, and a group of radio stations corresponding to a set of preprogrammed channel select buttons of a digitally tuned car stereo.

What is needed is a system and method for easily reconfiguring an apparatus to suit a particular user without having to go through the tedious process of entering a set of configuration settings.

What is needed is a system and method that allows a portable radios to be reconfigured without replacing any hardware.

What is needed is a system and method that allows portable radios to be easily shared among a plurality of users that avoids the tedious process of entering a set of configuration settings for each user.

Generally a system and method which overcomes the above mentioned shortcomings of the prior art is needed.

### BRIEF DESCRIPTION OF THE FIGURES

The features of the invention believed to be novel are set forth in the claims. The invention itself, however, may be best understood by reference to the following detailed description of certain exemplary embodiments of the invention, taken in conjunction with the accompanying drawings in which FIG. 1 is a perspective view of a wireless communication device according to a preferred embodiment of the invention.

FIG. 2 is a block diagram of the wireless communication device shown in FIG. 1 according to a preferred embodiment of the present invention.

FIG. 3 is a flow diagram of a process performed by the wireless communication device shown in FIG. 1 according to a preferred embodiment of the invention.

FIG. 4 is a flow diagram of a process performed by the wireless communication device shown in FIG. 1 according to a preferred embodiment of the invention.

FIG. 5 is a flow diagram of a follow on process performed by the wireless communication device shown in FIG. 1 according to a preferred embodiment of the invention.

FIG. 6 is a flow diagram of a follow on process performed by the wireless communication device shown in FIG. 1 according to a preferred embodiment of the invention.

FIG. 7 is a flow diagram of a follow on process performed by the wireless communication device shown in FIG. 1 according to a preferred embodiment of the invention.

FIG. 8 is a first part of a flow diagram of a process performed by the wireless communication device shown in FIG. 1 according to a preferred embodiment of the invention.

FIG. 9 is a continuation of the flow diagram shown in FIG. 8.

FIG. 10 is a block diagram of a controller for a wireless communication network.

FIG. 11 is a flow diagram of a process performed by the controller shown in FIG. 10 according to a preferred embodiment of the invention.

FIG. 12 is a first part of a flow diagram of a process performed by the controller shown in FIG. 10 according to a preferred embodiment of the invention.

FIG. 13 is a block diagram of a reconfigurable apparatus according to a preferred embodiment of the invention.

FIG. 14 is a flow diagram of a process performed by the reconfigurable apparatus shown in FIG. 13 according to a preferred embodiment of the invention.

FIG. 15 is a block diagram of a remote control according to a preferred embodiment of the invention.

FIG. 16 is a flow diagram of a process performed by the remote control shown in FIG. 15 according to a preferred embodiment of the invention.

FIG. 17 is a flow diagram of a process performed by the remote control shown in FIG. 15 according to a preferred embodiment of the invention.

FIG. 18 is a flow diagram of a process performed by the wireless radio shown in FIGS. 1 and 2 according to a preferred embodiment of the invention.

### DETAILED DESCRIPTION OF THE PREFERRED EMBODIMENTS

While this invention is susceptible of embodiment in many different forms, there are shown in the drawings and will herein be described in detail specific embodiments, with the understanding that the present disclosure is to be considered as an example of the principles of the invention and not intended to limit the invention to the specific embodiments shown and described. Further, the terms and words used herein are not to be considered limiting, but rather merely descriptive. In the description below, like reference numbers are used to describe the same, similar, or corresponding parts in the several views of the drawings.

Referring to FIG. 1, an perspective view of a wireless communication device 100, specifically, a portable radio, is shown. The portable radio comprises an antenna 102 speaker 104, a push to talk button 106, a liquid crystal display 108, a keypad 110, and a microphone 112.

A fingerprint sensor 114 is born upon the push to talk button 106, such that when a user pushes the push to talk button 106, his or her finger or thumb will be in position to be read by the fingerprint sensor 114. The fingerprint sensor can be for example one of the known types including optical, thermal, resistive, and capacitive. Preferably, the fingerprint sensor is a capacitive type. Capacitive type fingerprint sensors are manufactured by Identix, Inc. of Sunnyvale, Calif.

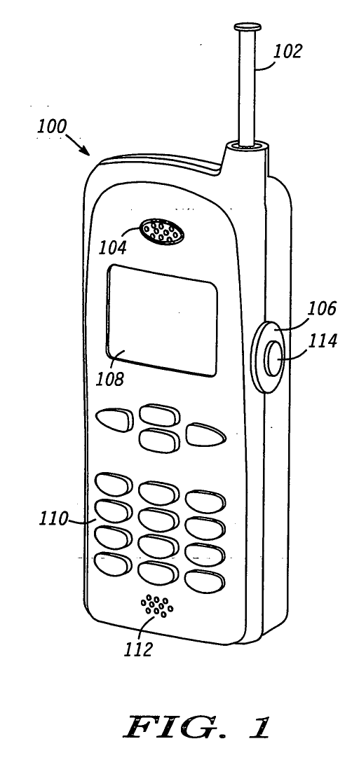

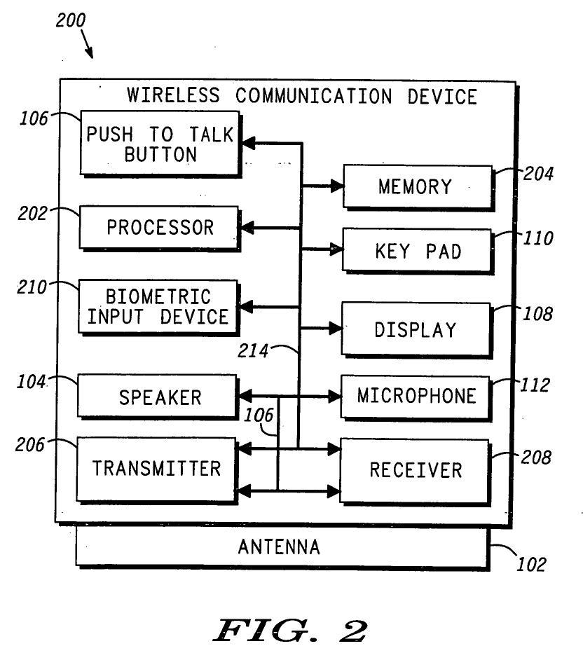

FIG. 2 shows a block diagram 200 of the wireless communication device 100 (FIG. 1). In addition to the elements shown in FIG. 1, in FIG. 2 the following components are shown:

a processor 202, preferably a microprocessor; any general purpose microprocessor is suitable to serve as processor 202; one particular processor which is suitable is the MCORE process or manufactured by Motorola, Inc. of Schaumburg, Ill.;

a memory 204, which can include both random access memory (RAM), and electrically erasable programmable read only memory (EEPROM);

a transmitter 206; and

a receiver 208.

The wireless communication device 100, as seen in block diagram 200, also comprises a biometric input device 210 which preferably, as discussed in connection with FIG. 1, takes the form of a fingerprint sensor 114 born on the push to talk button 106. Alternatively, the biometric input device 212 can, for example, comprise a retinal scanner, iris scanner, face scanner, hand print scanner, or scent scanner.

The speaker 104, microphone 112, transmitter 206, and receiver 208 are coupled together by a first electrical interconnection 212, which can be digital, analog, or a hybrid interconnection comprising analog and digital parts and digital to analog (D/A) and analog to digital (A/D) conversions

The receiver 208, transmitter 206, the display 108, the biometric input device 210, the keypad 110, the processor 202, the memory 204, and the push to talk button 106, are connected by a digital system bus 214. The digital system bus 214 electrically couples the fingerprint sensor 114 (FIG. 1), to the transmitter 206, and to the button 106 (FIG. 1).

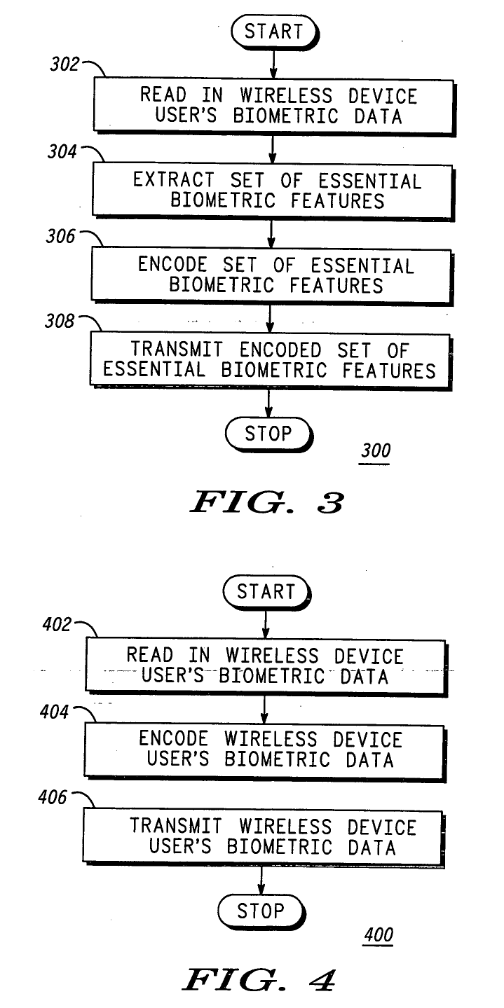

Referring to FIG. 3, a flow diagram of a process 300 performed by the wireless communication device 100 (FIG. 1) is shown.

In process block 302, a user's biometric data, preferably a user's fingerprint, is read through the biometric input device 210 (FIG. 2), 114 (FIG. 1).

In process block 304, a set of essential biometric features is extracted from the user's biometric data read in process block 302. In the preferable case that the biometric data is fingerprint data, the essential biometric features can comprise a set of fingerprint minutiae. Research into routines for extracting essential features from fingerprints, for the purpose of identifying and comparing fingerprints, started at least as far back as the early 1970's.

Currently there is a large body of published literature and issued patents on different techniques for identifying and comparing fingerprints. These prior publications teach a variety of methods that can be used to identify and compare fingerprints that are useful in connection with the present invention. The invention is not limited to any particular existing or future technique for extracting essential biometric features from fingerprints for the purpose of identifying and comparing fingerprints. At this mature stage in the development of the field there are a number of commercially available software libraries for identifying and comparing fingerprints that could be used in connection with the present invention. A suitable set of routines for extracting fingerprint minutiae and comparing fingerprints based on extracted fingerprint minutiae is sold by Identix of Sunnyvale, Calif. Another software package for fingerprint matching is the Secure Suite Software produced by Ethentica of Lake Forest, Calif. Still others are sold under the name the “U.are.U” by DigitalPersona, Inc. of Redwood City, Calif. An example from the large body of literature of a paper which discusses methods that can be used in the detection and comparison of Fingerprints is “Direct Gray-Scale Minutiae Detection in Fingerprints,” IEEE tPAMI version 19 NO. 11997, D. Maio, D. Maltoni.

The essential set of biometric features is preferably independent of variables in the measurement process such as the positioning (e.g., orientation) of the user's finger on the fingerprint sensor 114. Therefore, whereas the biometric data may vary from one measurement to another, the essential biometric features are substantially fixed, and can be used to identify a particular user.

A program which performs process block 304 falls under the general category of pattern recognition programs. A pattern recognizer (pattern recognition program) for performing process block 304 can be stored in the memory 204 (FIG. 2) and run on the processor 202 (FIG. 2).

In process block 306, the set of essential biometric features are encoded in preparation for transmission. The essential biometric features can be encoded using the following Associated Public-Safety Communication Officers (APCO), Motorola Data Communications (MDC), Improved Multi-band Excitation(IMBE), or Vector Sum Excites Linear Prediction (VSELP) signaling methods, the latter three being Motorola standard encoding schemes.

The set of essential biometric features is preferably encrypted prior to being encoded for transmission, to avoid the possibility of interception and misuse by an unauthorized party. Standard DES type encryption can be used.

An encoded set of fingerprint minutiae is approximately 300 bytes.

Process block 306 can be accomplished by an encoder program stored in memory 204 (FIG. 2) and run by processor 204 (FIG. 2).

In process block 308, an encoded set of essential biometric features is transmitted using transmitter 206 (FIG. 2).

Referring to FIG. 4, a flow diagram of an alternative process 400 to process 300 (FIG. 3) is depicted. In process block 402 the wireless communication device user's biometric data is read via biometric input device 210 (FIG. 2). In process block 404 the user's biometric data is encoded. In process block 404, the encoded biometric data is transmitted via transmitter 206 (FIG. 2). Note, that in process 400 the biometric data is transmitted as opposed to the set of essential features extracted by the pattern recognition program as is done in process 300 (FIG. 3). In the case of fingerprint type biometric data the Joint Photographic Expert Group (JPEG) standard can be used to encode the fingerprint as an image file.

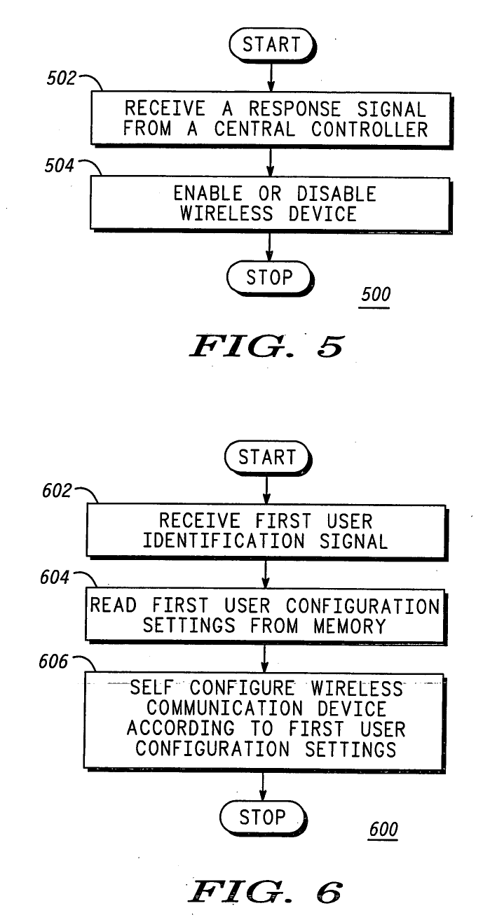

Referring to FIG. 5, a flow diagram of a follow on process performed by the wireless communication device 100 (FIG. 1) according to a preferred embodiment of the invention is shown.

In process block 502, a response signal, in response to the encoded biometric data transmitted in process block 404 (FIG. 4) or to the essential biometric features transmitted in process block 308 (FIG. 3)is received from a controller through receiver 208 (FIG. 2).

In process block 504, at least one function of the wireless device is either enabled or disabled according to the nature of the response signal by the processor 202 (FIG. 2)

Referring to FIG. 6 a flow diagram of a follow on process 600 performed by the wireless communication device 100 (FIG. 1) is shown.

In process block 602, a signal identifying a first user is received through the receiver 208 in response to the encoded biometric data transmitted in process block 404 (FIG. 4) or to the essential biometric features transmitted in process block 308 (FIG. 3).

In process block 604, a set of one or more configuration settings corresponding to the first user is read from memory 204 (FIG. 2). Memory 204 (FIG. 2) may contain one or more sets of one or more configuration settings. The set of configurations settings applicable to the first user is selected based on the identifying signal received in process block 602.

In process block 606, the wireless communication device 100 (FIG. 1) self configures according to the set of one or more configuration settings applicable to the first user. The processor 202 (FIG. 2) runs a program which carries out the configuration process.

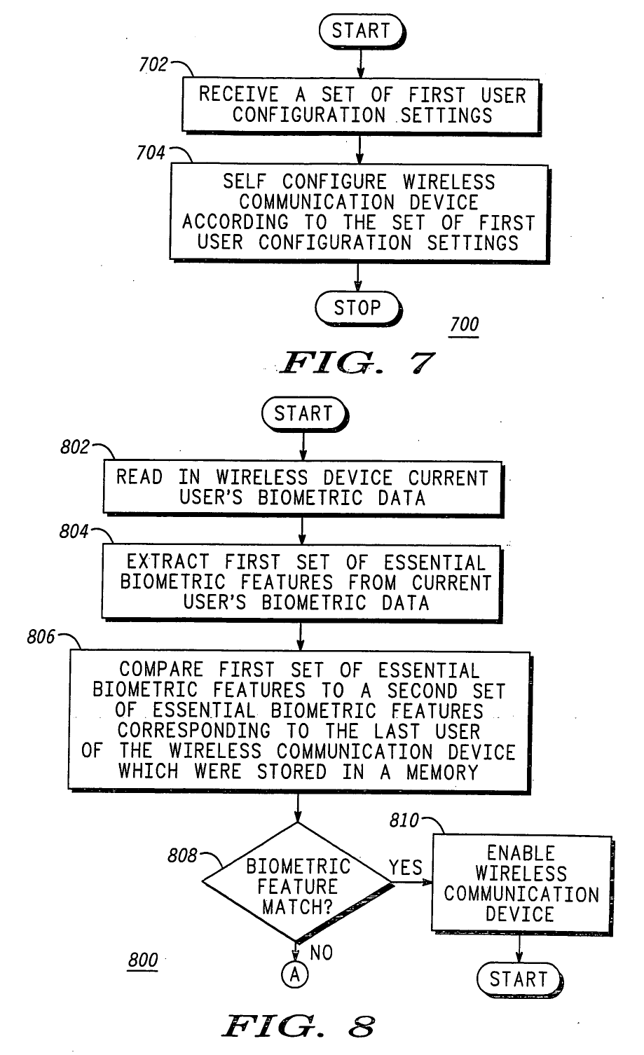

Referring to FIG. 7, a flow diagram of a follow on process 700 performed by a wireless communication device 100 (FIG. 1) is shown.

In process block 702, a set of first user configuration settings is received through the receiver 208 in response to the encoded biometric data transmitted in process block 404 (FIG. 4) or to the essential biometric features transmitted in process block 308.

In process block 704, the wireless communication device 100 (FIG. 1) self configures according to the set of one or more configuration settings applicable to the first user. The processor 202 (FIG. 2) runs a program which carries out the configuration process.

FIGS. 8-10 show a flow diagram 800 of a process performed by the wireless communication device 100 (FIG. 1) according to a preferred embodiment of the invention.

In process block 802, a current user's biometric data is read by the biometric input devices device 210 (FIG. 2), 114 (FIG. 1).

In process block 804, a first set of essential features is extracted from the current user's biometric data. The latter action can be performed by a pattern recognition program which in the case of fingerprint type biometric data can be a fingerprint minutiae program. The essential features can be encoded by an encoder into a small byte size data structure and stored in memory 204 (FIG. 2). The encoder can be a program stored in memory 204 (FIG. 2) and run by processor 202. The aforementioned small byte size data structure is a representation of one or more features selected from the first set of essential biometric features.

In process block 806, the first set of biometric features is compared to a second set of essential biometric features which correspond to the last user of the wireless communication device, which were previously stored in memory 204 (FIG. 2), and which are read therefrom for performing the comparison. The comparison can be performed by a comparator which is implemented as a program stored in memory 204 and run by processor 204.

Process block 808 is a decision block, the outcome of which depends on whether the first set of essential biometric features matches the second set of essential biometric features.

If the outcome of process block 808 is a determination of a match, then in process block 810 at least one function of the wireless communication device 100 (FIG. 1) is enabled. The processor 202 (FIG. 2) can issue a comparison output signal to trigger the wireless communication device 100 (FIG. 1) to be enabled.

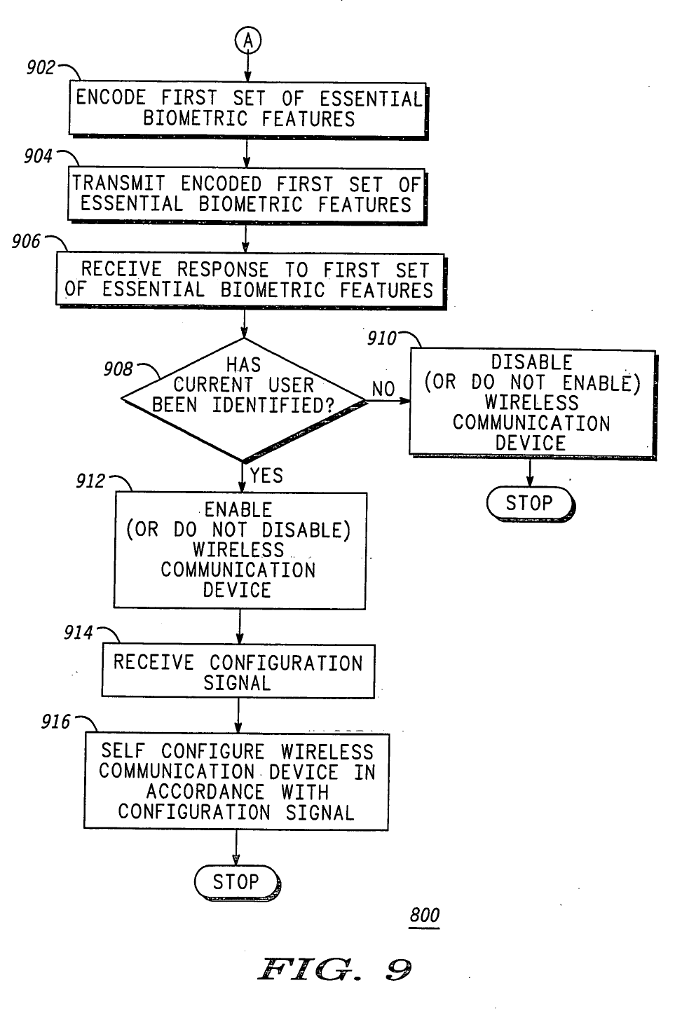

If the outcome of process block 808 is a non match, then the process continues with process block 902 (referring now to FIG. 9), in which the first set of essential biometric features is encoded to produce a first data item. The first data item is derived from the first set of essential biometric features. The first data item is an optionally compressed and/or encoded version of the first set of essential biometric features, that is suitable for transmission by wireless transmitter 206 (FIG. 2).

In process block 904, the first set of essential biometric features in the form of the first data item is transmitted by transmitter 206 (FIG. 2).

In process block 906, a first signal in response to the first set of essential biometric features is received by the receiver 208. The response indicates if the current user has been identified by a recipient (e.g., a controller for a wireless communication system) that received the first set of essential biometric features transmitted in process block 904.

Process block 908 is a decision block, the outcome of which depends on whether the current user has been identified. If the current user has not been identified, then in process block 910 the wireless communication device 100 (FIG. 1) is disabled (or not enabled depending on the default state).

If in process block 908, the current user has been identified, then the process continues with process block 912 in which the wireless communication device 100 (FIG. 1) is enabled (or not disabled depending on the default state).

The processor 202 (FIG. 2) sets the state of the wireless communication device in carrying out process blocks 910 (FIG. 9), and 912.

In process block 914, a configuration signal is received via receiver 208 (FIG. 2).

In process block 916, the processor 202 (FIG. 2) configures the wireless communication device in accordance with the signal received in process block 914.

Configuration settings may be received in the configuration signal or read from a preselected memory based on an information received in the configuration signal.

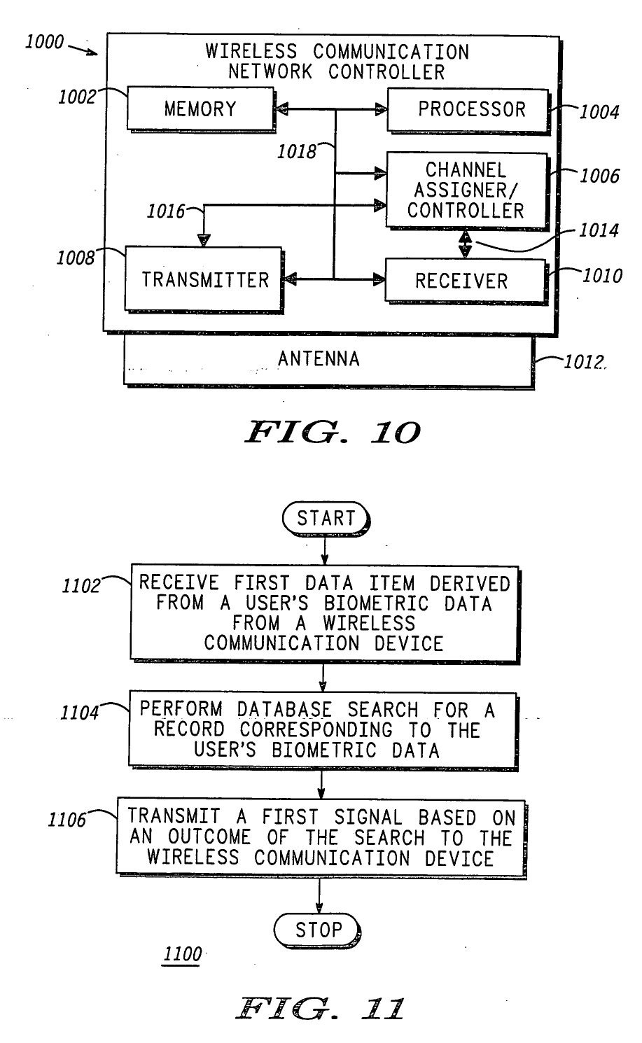

Referring to FIG. 10, a block diagram of a wireless communication network controller 1000 is shown. The controller comprises: a memory 1002, a processor 1004, a channel assignor/control 1006, a transmitter, 1008, a receiver 1010, and an antenna 1012. The controller 1000 may interact with a wireless network through a non-wireless network, in which case the antenna 1012 would be replaced by another type of physical layer communication interface suitable for the non-wireless network.

The channel assignor/controller 1006 is connected to the receiver through a first internal communication channel 1014. The channel assignor/controller 1006 is connected to the transmitter 1008 through a second internal communication channel 1016.

The transmitter 1008, receiver 1010, channel assignor/controller 1006, memory 1002, and processor 1004, are connected by a common bus 1018.

Referring to FIG. 11, a flow diagram of a process performed by the controller 1000 (FIG. 10) is shown.

In process block 1102, a first data item derived from a user's biometric data is received from the wireless communication device 100 (FIG. 1). In the case of fingerprint data, the biometric data preferably comprises fingerprint minutiae.

In process block 1104, a search is performed in a database by a database engine for a record corresponding to the user's biometric data. The database can be stored in memory 1002 (FIG. 10). The database engine can comprise a program stored in memory 1002 (FIG. 10) and run on processor 1004 (FIG. 10).

In process block 1106, the first signal based on an outcome of the search is transmitted by transmitter 1008 to the wireless communication device 100 (FIG. 1). This first signal can be the first signal received in process block 906 (FIG. 9), the response signal received in process block 502 (FIG. 5), the first user identification signal 602 (FIG. 6), or the set of configuration settings received in process block 702 (FIG. 7).

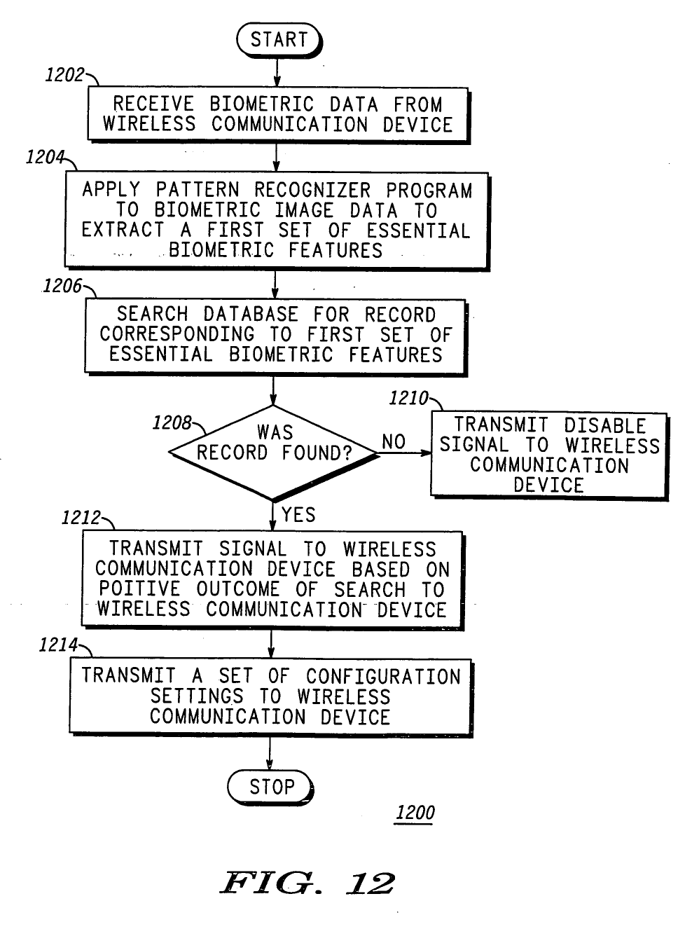

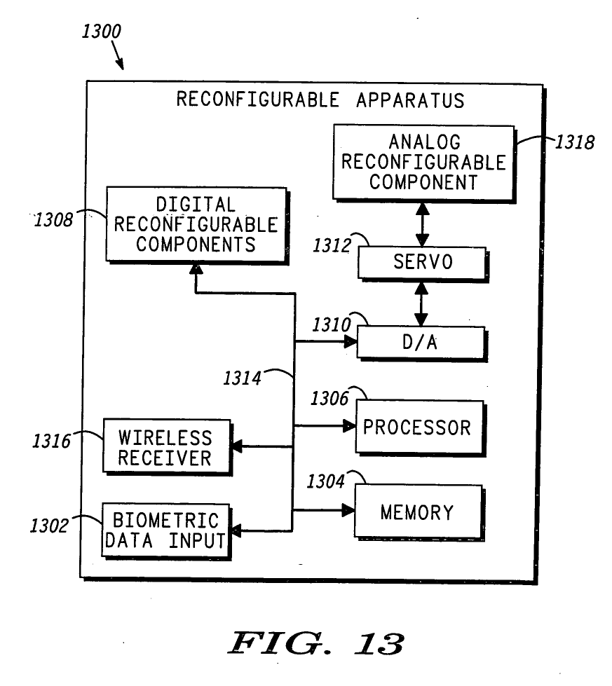

Referring to FIG. 12, a first part of a flow diagram of a process 1200 performed by controller 1000 (FIG. 10) is shown.

In process block 1202, biometric data is received from the wireless communication device 100 (FIG. 1). The biometric data received in process block 1202 can correspond to the biometric data transmitted in process block 406 (FIG. 4).

In process block 1204, a pattern recognizer is applied to the biometric data to extract a first set of essential biometric features that characterize the biometric data. The pattern recognizer can be implemented as a pattern recognition program that is stored in memory 1002, and run on processor 1004. In the case of fingerprint biometric data, the pattern recognizer can be based on a fingerprint minutiae program.

In process block 1206, a search is conducted in a database by a database engine for a record corresponding to the first set essential biometric features. The database which can contain records corresponding to one or more sets of essential biometric features can be stored in memory 1002 (FIG. 10). The database engine can comprise a program which is stored in memory 1002 (FIG. 10) and run by processor 1004 (FIG. 10).

Process block 1208 is a decision block, the outcome of which depends on whether a record corresponding to the first set of essential biometric features was found.

If not, then in process block 1210 a disable signal is transmitted via transmitter 1008 (FIG. 10) to the wireless communication device 100 (FIG. 1). Alternatively, the wireless communication device could default to a disabled state after process block 406, in which case, in lieu, of sending a signal in process block 1210, simply not sending a signal will achieve the desired result of leaving the wireless communication device 100 in a disabled state (until biometric data corresponding to a record in the database is received).

If a record corresponding to the first set of essential biometric features was found, then the process continues with process block 1202 in which a signal is transmitted via transmitter 1008 (FIG. 10) to the wireless communication device. The signal reflects the positive outcome of the search.

In process block 1204, a set of configuration settings is transmitted via transmitter 1008 (FIG. 10) to the wireless communication device.

FIG. 13 is block diagram of a reconfigurable apparatus 1300. The reconfigurable apparatus can, for example, be an audio graphic equalizer, a car, a car stereo, or a wireless radio.

The reconfigurable apparatus comprises a digital signal bus 1314.

The reconfigurable apparatus 1300 comprises a biometric data input 1302 electrically coupled to the digital signal bus. The biometric data input preferably comprise a biometric sensor, more preferably, a fingerprint sensor. Alternatively, the biometric data input 1302 can comprise a wireless receiver for receiving biometric data transmitted by a separate device, preferably a remote control.

A memory 1304 and a processor 1306 are coupled to the digital signal bus 1314. The memory can be used to hold one or more programs used to operate and configure the reconfigurable apparatus 1300, and can also be used to store one or more sets of one or more configuration settings for the reconfigurable apparatus.

One or more digital reconfigurable components 1308 are coupled to the digital signal bus 1314. A digital reconfigurable component is a component that can be reconfigured by writing one or more digital signals to it. Examples of digital reconfigurable components include: a set of radio stations corresponding to a set of preprogrammed buttons of a car radio, one or more parameters used by an engine or suspension control computer, or digitally controlled climate control systems.

An analog reconfigurable component 1318 is drivingly coupled to a servo 1312, which is drivingly coupled to the output of digital to analog converter (D/A) 1310. An input of the digital to analog converter 1310 is connected to the digital signal bus. The processor 1306 running a program stored in memory 1304 can read settings from memory 1304 and write signals derived from the settings to the digital to analog converter, the digital to analog converter then drives the servo which sets a configuration of the analog configurable component 1318.

Examples of analog reconfigurable components include a motorized adjustable car seat, or power mirrors. An adjustable car seat could also constitute an digital reconfigurable component if a stepper motor is used to control the adjustment, however the such motors are more costly. In the case of car seat the biometric data input is preferably a fingerprint sensor which is placed on a door handle place of a car door, so that when the user opens the door and touches the fingerprint sensor the seat will be reconfigured to suit the user.

A wireless receiver 1316, for receiving wireless transmissions, is also coupled to the digital signal bus 1314.

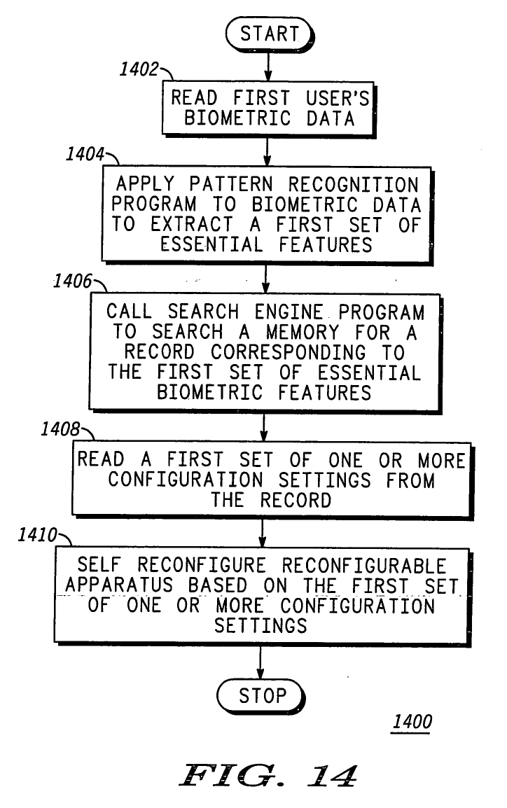

Referring to FIG. 14, a flow diagram of a process 1400 performed by the reconfigurable apparatus 1300 is shown.

In process block 1402, a first user's biometric data is read through the biometric data input 1302 (FIG. 13).

In process block 1404, a pattern recognition program (pattern recognizer) is called to extract a first set of essential biometric features. In the case of fingerprint data the first set of essential biometric features, is a set of fingerprint minutiae which characterize the first user's fingerprint. The pattern recognition program can be stored in memory 1304 (FIG. 13) and run by processor 1306 (FIG. 13).

In process block 1406, a search engine is called to search memory 1304 for a first record corresponding to the first set of essential biometric data. The search engine can be a program stored in memory 1304 (FIG. 13) and run by processor 1306 (FIG. 13).

In process block 1408, a first set of one or more configuration settings is read by processor 1306 (FIG. 13) from the first record located in process block 1406.

In process block 1410 the reconfigurable apparatus 1300 (FIG. 13) self reconfigures based on the first set of one or more configurations settings read in process block 1408.

The reconfiguration may be accomplished by a reconfiguration sub program which is stored in memory 1304 (FIG. 13) runs on processor 1306 (FIG. 13). The reconfiguration sub program reads the first set of one or more configuration settings, and writes one or more digital signals to the digital reconfigurable components 1308 (FIG. 13), and/or the digital to analog converter 1310 (FIG. 13).

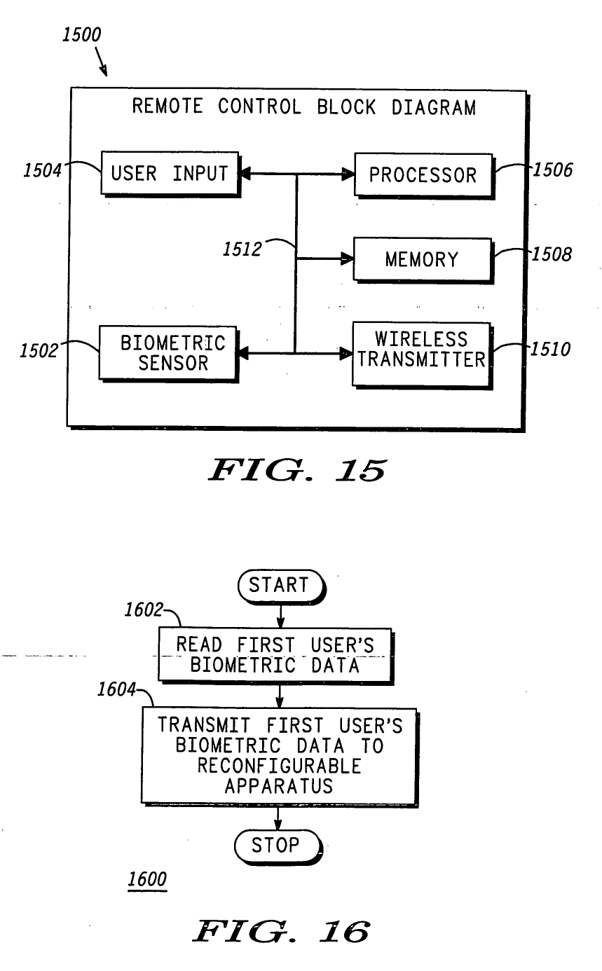

FIG. 15 is a block diagram of a remote control 1500 according to a preferred embodiment of the invention.

The remote control comprises a digital signal bus 1512.

The remote control comprises a biometric sensor 1502, preferably a fingerprint sensor coupled to the digital signal bus.

A wireless transmitter 1510 for transmitting signals to configure and control a device is coupled to the digital signal bus.

A memory 1508 is coupled to the digital signal bus.

A processor 1506 is coupled to the digital signal bus.

A user input 1504, preferably, a key pad is coupled to the digital signal bus. The user input can be used to enter in commands to control a reconfigurable apparatus such as a audio graphic equalizer.

FIG. 16 is a flow diagram of a process 1600 performed by the remote control 1500 (FIG. 15) according to a preferred embodiment of the invention.

In process block 1602, a first user's biometric data is read by the biometric sensor 1502 (FIG. 15)

In process block 1604, the first user's biometric data is transmitted by wireless transmitter 1510 (FIG. 15) to the reconfigurable apparatus 1300 (FIG. 13), which reads the first user's biometric data in process block 1402.

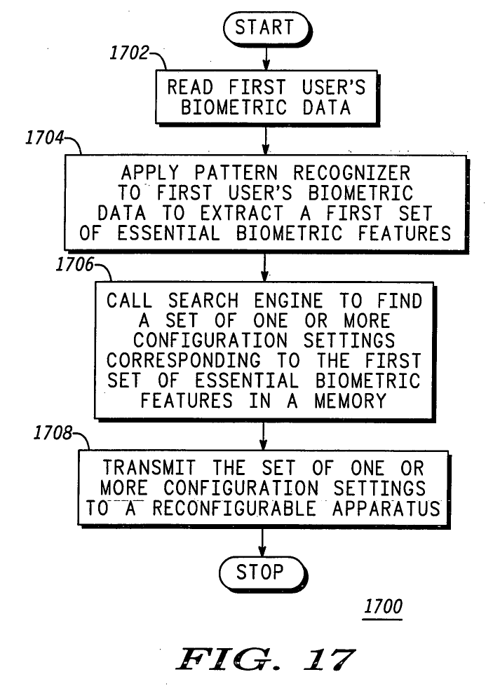

FIG. 17 shows a flow diagram of a process 1700 performed by the remote control 1500 (FIG. 15) according to a preferred embodiment of the invention.

In process block 1702, a first user's biometric data is read by the biometric sensor 1502.

In process block 1704, a pattern recognizer is applied to the first user's biometric data to extract a first set of essential biometric features. The pattern recognizer can be realized as a pattern recognition program stored in memory 1508 (FIG. 15), and run by processor 1506 (FIG. 15). In the preferred case of fingerprint biometric data, the pattern recognition program can be a program for extracting a set of fingerprint minutiae.

In process block 1706, a search engine is called to find, in memory 1508 (FIG. 15), a set of one or more configuration settings corresponding to the first set of essential biometric features. The search engine can be realized as a program stored in memory 1508 (FIG. 15) and run by processor 1506 (FIG. 15). The memory 1508 (FIG. 15) can store one or more sets of one or more configuration settings corresponding to one or more users. Each set is stored in association with essential biometric data corresponding to a particular user or an identifier correlated to the essential biometric data for the particular user.

In process block 1708 the set of one or more configuration settings found in process block 1706 is transmitted by transmitter 1510 to the reconfigurable apparatus 1300 (FIG. 13).

The reconfigurable apparatus used in connection with process 1700 need not perform a pattern recognition function since that function has been off loaded to the remote control 1500 (FIG. 15) according to process 1700. A reconfigurable apparatus used in connection with the remote control 1500 (FIG. 15) operating according to process 1700 can comprise: a wireless receiver 1316 (FIG. 13) for receiving the first set of one or more configuration settings, a first memory 1304 (FIG. 13) for storing an active set of one or more active configuration settings, and a processor 1306 (FIG. 13) for reading the first set of one or more configuration settings and writing the first set of one or more configuration settings to the first memory 1306 (FIG. 13). The biometric data input 1302 (FIG. 13) is superfluous for use with a remote control 1500 (FIG. 15) operating according to process 1700 case, since the biometric data is read by the remote control 1500 (FIG. 15).

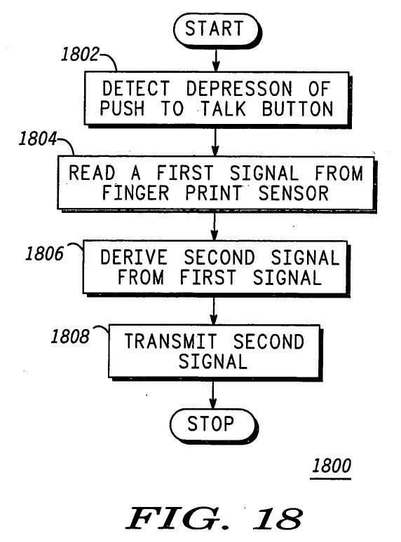

FIG. 18 shows a flow diagram of a process 1800 performed by the wireless communication device 100 depicted in FIG. 1 and, as a block diagram, in FIG. 2.

In process block 1802 depression of the push to talk button 106 is detected. Depression of the push to talk button may trigger an interrupt of processor 202.

In process block 1804 a first signal is read from the fingerprint sensor 114. The processor 202 may perform the read.

In process block 1806 a second signal is derived from the first signal. The second signal is preferably an encoded (e.g., JPEG) image of a fingerprint of a user who depressed the push to talk signal. Alternatively, the second signal can comprise an encoded set of fingerprint minutiae derived from the first signal.

In process block 1808 the second signal is transmitted.

According to preferred embodiments of the present invention, a system and method which facilitates rapid configuration of a wireless communication device or other reconfigurable apparatus is provided.

Further, in the case of a wireless communication device, a system and method is provided for assuring that a set of configuration settings properly corresponds to the current user. This accomplished automatically without the user having to go through a tedious configuration process or exchange a hardware component, e.g., smart card.

What is claimed is:

1-15. (canceled)

16-21. (canceled)

22-25. (canceled)

26. A reconfigurable apparatus comprising:
an input device for receiving a first user's biometric data;
a first memory for storing a plurality of sets of one or more configuration settings corresponding respectively to a plurality of users' biometric data; and
a search engine for finding a first set of one or more configuration settings corresponding to the first user's biometric data in the first memory.

27. The reconfigurable apparatus according to claim 26 wherein:
the input device comprises a biometric reader.

28. The reconfigurable apparatus according to claim 26 wherein:
the biometric reader comprises a fingerprint reader.

29 The reconfigurable apparatus according to claim 26 wherein:
the input device comprises a wireless receiver.

30. The reconfigurable apparatus according to claim 26 further comprising:
a pattern recognizer for extracting a first set of essential biometric features from the first user's biometric data.

31. A remote control comprising:
a biometric sensor for reading in a biometric data set from a user.

32. The remote control according to claim 31 wherein the biometric sensor comprises:
a fingerprint sensor.

33. The remote control according to claim 31 further comprising:
a wireless transmitter for transmitting the biometric data set to a reconfigurable apparatus.

34. The remote control according to claim 33 wherein the biometric sensor comprises:
a fingerprint sensor.

35. The remote control according to claim 31 further comprising:
a pattern recognizer for extracting a first set of essential features from the biometric data; and
a transmitter for transmitting the first set of essential features to a reconfigurable apparatus.

36. The remote control according to claim 35 wherein the biometric sensor comprises:
a fingerprint sensor.

37. The remote control according to claim 31 further comprising:
a pattern recognizer for extracting a first set of essential features from the biometric data;
a memory for storing a plurality of sets of one or more configuration settings corresponding to a plurality of sets of essential biometric features;
a search engine for finding a first set of one or more configuration settings corresponding to the first set of essential biometric features in the memory; and
a transmitter for transmitting the first set of one or more configuration settings to a reconfigurable apparatus.

38. The remote control according to claim 37 wherein the biometric sensor comprises:
a fingerprint sensor.

39. A system comprising:
a remote control comprising:
a biometric sensor for reading in a biometric data set from a user;
a pattern recognizer for extracting a first set of essential features from the biometric data;
a memory for storing a plurality of sets of one or more configuration settings corresponding to a plurality of sets of essential biometric features;
a search engine for finding a first set of one or more configuration settings corresponding to the first set of essential biometric features in the memory; and
a wireless transmitter for transmitting the first set of one or more configuration settings; and
a reconfigurable apparatus comprising;
a receiver for receiving the first set of one or more configuration settings;
a first memory for storing an active set of one or more active configuration settings; and
a processor for reading the first set of one or more configuration settings writing the first set of one or more configuration settings to the first memory.

40. The system according to claim 39 wherein the biometric sensor comprises:
a fingerprint sensor.

41-42. (canceled)
